(19) United States
(12) Patent Application Publication
(10) Pub. No.: US 2013/0006649 A1
(43) Pub. Date: Jan. 3, 2013

(54) System and Method Healthcare Diagnostics and Treatment

(76) Inventors: Vasu Rangadass, Arlington, TX (US); Ravi Seshadri, Plano, TX (US); Partha Raghunathan, Coppell, TX (US); Nita Pledger, Colorado Springs, CO (US); Krishnamohan Balachandran, Belmont, CA (US)

(21) Appl. No.: 12/560,544

(22) Filed: Oct. 21, 2009

Related U.S. Application Data
(60) Provisional application No. 61/100,509, filed on Sep. 26, 2008.

(51) Int. Cl. G06Q 50/22

(52) U.S. Cl. 705/2

(57) ABSTRACT

A computerized decision support system for designing, managing and executing clinical disease pathways for financially balanced evidence based care.

### CROSS-REFERENCE TO RELATED APPLICATIONS

Applicant claims priority based on provisional application Ser. No. 61/100,509 filed on Sep. 26, 2008, the entire content of which are incorporated herein by reference

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is an example diagram of a clinical pathway for a type of cancer;

FIG. 2 illustrates a sample high level pathway for heart failure; and

FIG. 3 illustrates work up orders and a procedure.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

A clinical pathway is a treatment guideline for a patient having a certain procedure done or a patient who has a certain illness. Since all patients are unique, everyone's care needs to be customized to meet their needs while keeping the guidelines in mind. Clinical pathways are used to describe and implement clinical standards or best practices—for example—“always administer a PSA test for all males over the age of 40”, or “always perform a baseline PET/CT scan prior to beginning any first line non surgical therapy for a cancer patient”. They help to provide quality and efficient patient care, in some cases, even “cost effective” patient care. The physician orders clinical pathways for appropriate patients.

A clinical pathway generally comprises an initiating step, intermediate process steps tied through decision block steps, and a result step. The result step of a pathway usually comprises instructions such as “Generate Order” or “Perform Action” wherein a “Generate Order” result step may comprise several different types of orders such as Procedures (e.g. perform biopsy); Labs (eg. complete blood count panel or cbc); Radiology (e.g. full body PET/CT scan); Medications (e.g. carboplatin 75 mg/m2 IV on day 1, and 1,000 mg/m2/day by continuous intravenous infusion over 24 hours or day 1, 2, 3, 4); and various other orders for patient treatment as determined by a patient's clinical pathway. “Perform Action” result step may comprise various types of actions such as: generate appointment schedule (e.g. 4 cycles of 5 daily visits, every 28 days); descriptive actions regarding treatment (e.g. Terminate first line of therapy and resume conservative palliative care); further procedures required; and various other actions that may be required for further treatment of a patient.

Each step within a pathway may comprise the following attributes: Resources (eg. facility, machines); Material (eg. clinical supplies such as IV drip, syringes etc.); Drugs; Human Resources (eg. nurse); and Cost (eg. both absolute and hourly/weekly for HR resources).

From an end-user point of view there are two types of pathways—a multi-result or process pathway and single result or linear pathway. The multi-result or process pathway includes several individual related pathways described in one model using decision blocks. For example, if patient has stage-1 lung cancer, then do: a) resection, if tumor is bulky and patient is clinical candidate, or if tumor is non bulky and/or patient is not clinical candidate b1) first line platinum therapy or b2) neoadjuvant chemotherapy using cisplatin and radiation therapy xxy if patient has shown resistance to b1.

Use of clinical pathways has a number of benefits for a hospital. It establishes a standard of care for specified disorders and deviations from the clinical pathway can be studied so as to modify and improve care for each disorder. By standardizing care in accordance with the clinical pathways, the hospital can control costs and improve quality. A clinical pathway also indicates what is expected to happen to the patient for each day or other time period. Many of the events require a written physician order before the events can be carried out by other health professionals. During the order entry process, the physician must make sure that he writes orders for those events that should occur. If he does not, then the patient's stay in the hospital could potentially be extended, resulting in extra hospital and patient costs. Many hospitals have prepared pre-printed standard order-sets containing the necessary orders for each day on each clinical pathway to assist in this process.

In the current clinical setting, writing orders corresponding to a clinical pathway is a time consuming task for the physician. Typically, the steps performed by the physician in the present manual system are as follows: First, the physician determines whether the patient is already on a clinical pathway by looking in the patient's chart for a pathway, relying on his or her own knowledge and recollection of the patient's care, or generally expecting s a standard regimen to be followed. The physician must then determine whether standard order-sets exist for the pathway which is needed for the patient, if not already familiar with the pathway. If the physician is not familiar with the needed pathway the physician may consult with a peer, another provider, or an experienced nurse or other health care practitioner.

Second, if the patient is already on a clinical pathway, the physician then needs to associate the patient with a step on the clinical pathway in order to determine what standard order-sets to use. The physician must also determine if the patient is deviating from the clinical pathway. If the patient is not following the expected path, then his plan of care must be individualized to help the patient return to the expected course. The physician must determine whether the patient has other problems that require orders. In some cases, the physician needs to use standard order-sets from another clinical pathway because the patient has multiple problems. The physician must determine what standard order-sets have already been used. To determine this, the physician looks in another part of the patient's chart for the signed order-sets. In some situations, the physician may need to fill out more than one standard order-set. Finally, the physician must find the appropriate standard order-sets and must complete and sign the order-sets. The manual process can be cumbersome and time consuming. Often the process is so cumbersome, that the physician relies completely on the nursing or support staff to make sure the order-sets are completed.

Third, if the patient is not set up in a clinical pathway and needs to be, the physician needs determine if the patient is now eligible to be on a new clinical pathway and follow the sequence of steps till an order-set can be generated; and continue to monitor the patient.

Computerized medical information systems are widely used to monitor, control and record many aspects of patient care. Clinical pathways have been computerized to some extent; however, the generation and execution of order-sets based on the selection of the pathway has not been computerized. In addition, no computerized information systems are being used to continuously benchmark clinically pathways against actual clinical and financial outcomes. Moreover, no computerized information systems are being used to “optimize” a set of clinical pathways for a healthcare organization with a goal of maximizing financial and/or clinical key performance and/or quality indicators and/or risk measures.

Further, no computerized information systems are being used to “infer” commonly prevalent practices of healthcare organizations such as doctors' practices or hospitals for clinical pathways by inspecting their historical clinical and financial information. The present invention addresses the foregoing and other difficulties which have long since been associated with the prior art of clinical pathways and their application and use in the medical field. In accordance with the broader aspects of the invention, one embodiment of the invention comprises a computerized decision support system for inferring, designing, managing, executing and optimizing clinical pathways for patient care. The decision support system builds upon a commonly prevalent practices utilized by healthcare providers such as hospitals, doctor practices, and various providers responsible for diagnosing and determining a best course of treatment for a patient. The computerized decision support comprises utilities for analysis of commonly prevalent practices for clinical pathways by inspecting historical clinical and financial information in conjunction with clinical disease pathways to provide options for more financially balanced, evidence based patient care. The decision support system utilizes a pathway design component for authoring and revising pathways and an execution manager for implementing and managing events and activities which occur during execution of each clinical pathway.

The pathway design tool comprises a pathway designer which enables a user to author clinical pathways in a graphical and/or text-based screen editor. Standard pathway constructs are provided via a library to allow users to rapidly construct commonly utilized clinical pathways or edit and customize the pathways for certain patients or situations. Pathways constructed in this tool are deployed to a database. A pathway manager then instantiates and initiates a specific instance of a defined pathway, manages the execution of the pathway, and maintains the state of execution.

An execution engine comprising the decision support system implements each event as a specific instance of an activity type. The customization of an activity type includes specifying the text that is displayed to the user at execution time, any transfer of data that takes place during execution, emails that may be sent, services called, messages created, input received from the user, and the work item handler that will process the activity data.

An activity is a set of data and methods that are customized at design time and executed by the pathway manager. Activities are the events of the system. The execution of an activity has three components: a Before-Execution method, an Execution method, and an After-Execution method. This allows data to be transferred from, or to a database, service, or file before or after execution of the activity. Any required user interaction is handled by the work-item handler as part of the execution method. Any activities that do not require user interaction are processed automatically when triggered by an earlier activity in the pathway.

Activity types are event templates that are customized by modelers using the Pathway Designer and put together to implement a specific pathway. Activity types include not only the specific medical components of the pathway, but also the conditional expressions necessary to implement the sequencing of activities within the pathway. Specific medical components must be supplied as activity types to eliminate the requirement of a user to possess any programming knowledge or experience.

A worklist is a list of activities that are in a queue for a specific user (or role if using role-based activities). The worklist is stored within the pathway database and is available to the user when logged into the system. The user may choose which activity to process next, but activities may also be prioritized.

Activity handlers are customized for each activity type that requires human interaction. These handlers are developed according to each user's interface principles and styles. Customized handlers allow specific data fields to be accessed from a specific activity type rather than passing everything to the handler as an activity parameter. Such customized handlers enable each user to make their own activity handlers easy to use and access according to their own needs.

Activities may assigned to a role or to a specific user. Each user may have multiple roles assigned to them as needed. An activity is assigned either to a user or a role, but each activity may be assigned or reassigned during execution of the pathway as needed.

Persistence of an actively executing pathway is maintained by storing the state of the instance in pathway database tables. When the pathway execution engine is invoked, the database tables are read and instance data repopulated thereby allowing a pathway to maintain its state over long periods of time including during any processing interruptions.

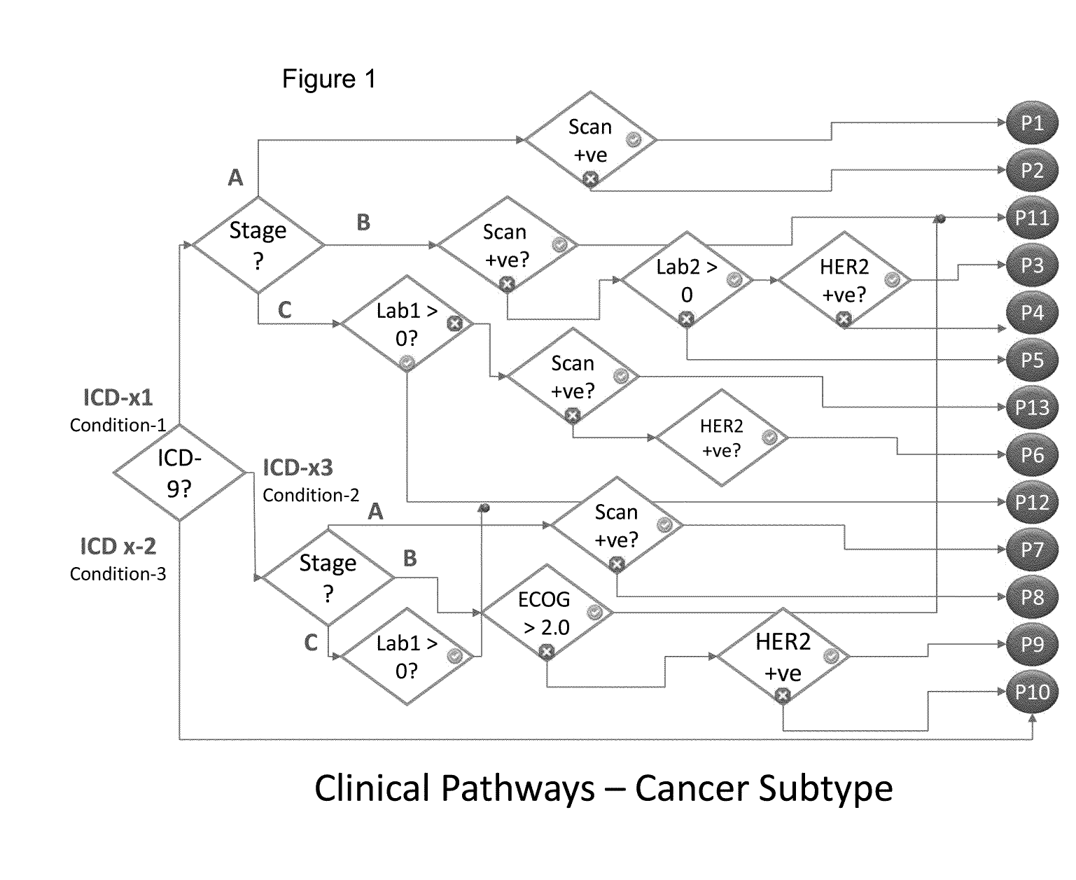

FIG. 1 shows an example of a clinical pathway for a cancer patient represented as a process chart which may be executed using the decision support system of the present invention. In this example, each of the pathways P1-P10 are decision blocks with each leading to three to five pathways. A single-result/linear pathway may comprise several decision blocks that make a single pathway valid. P1 is an example of a linear pathway.

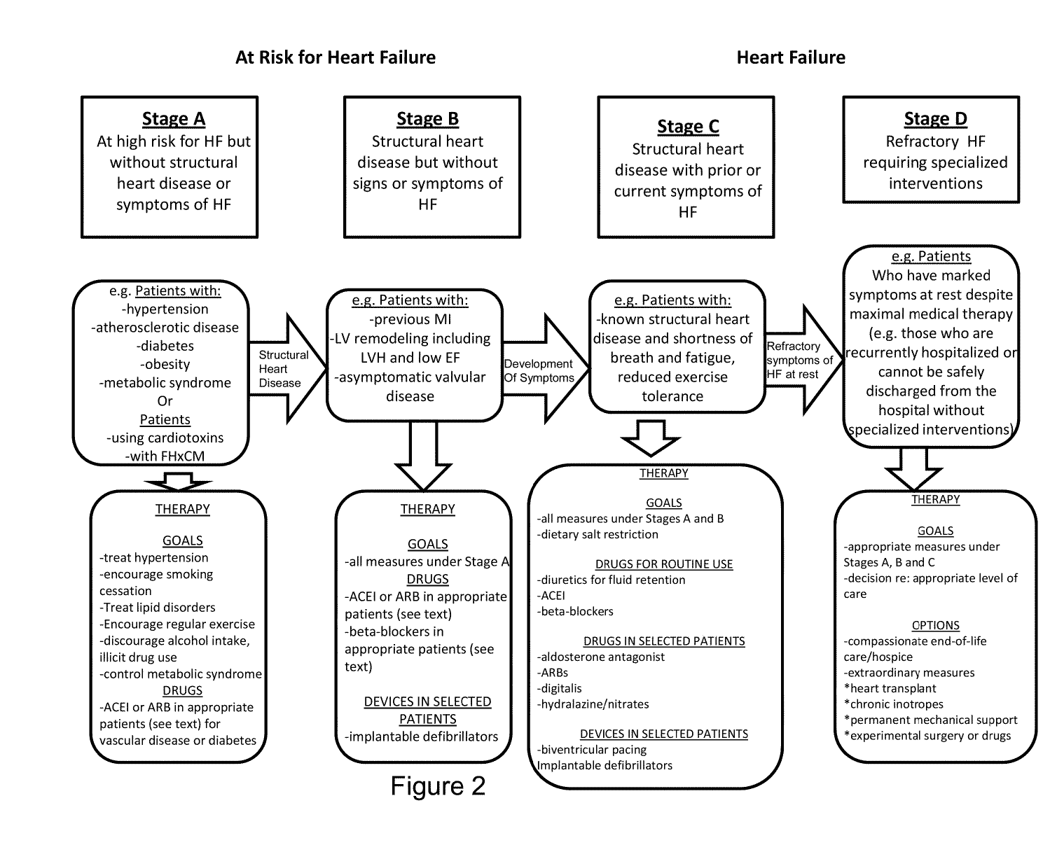

FIG. 2 illustrates a sample high-level pathway for heart failure recommended by the American College of Cardiology Foundation and the American Heart Association as of 2005.

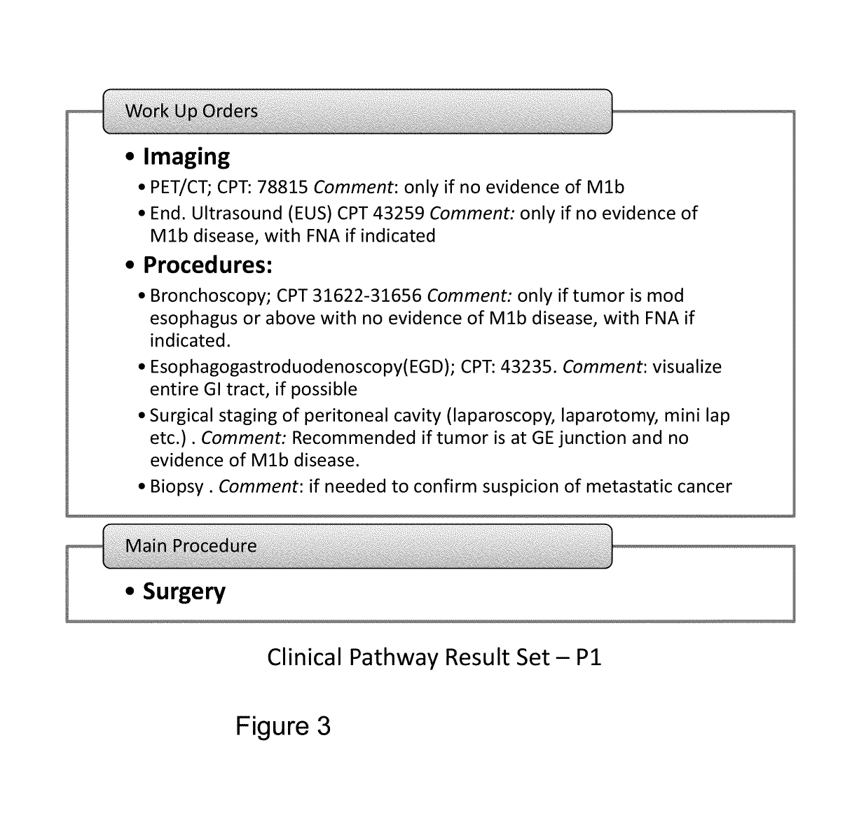

FIG. 3 illustrates an example of work up orders and a procedure for a patient having a tumor suspected to be cancerous.

To create a new pathway in the linear view, the following steps are used:

First, a Pathway Summary is established by entering a pathway name (eg. P1) and parent grouping (eg. Prostate Cancer).

Pathways usually have hierarchies at least 3 levels deep. For example: All Pathways->Cancer->Prostate Cancer. A Pathway Authoring tool allows users to create one pathway at a time, so in order to create a Process view of related pathways such as P1 through P12 as shown in FIG. 1, the user needs to group the pathways.

The computerized decision support system records the author and/or the user/modifier for each clinical pathway. For example, the author of an oncology pathway for treatment of a cancer patient following a pathway in FIG. 1 is most likely a medical doctor such as an oncologist. However, each pathway may comprise multiple authors and/or modifiers as treatment plans are revised and improved during the patient's treatment and care.

Pathways may be grouped by Type including Treatment, Diagnostic, and Research and grouped by Status including Approved, Work in Progress, Pending Approval, Investigative, Not Approved, and Deprecated.

A Search Library provided within the computerized decision support system enables a pathway author to type a question and search for existing criteria or decision blocks and modify the “correct outcome” for selected decision blocks. For example, a search on “diagnosis” could bring up: “What is the patient's ICD-9 diagnosis code?”, “Is patient's ICD-9 code=150.x?” etc. If a desired decision block is not present in library, the system allows the author to add a new decision block. Types of decision blocks include: True/False, Multiple Choice, Number etc. Each block also has optional comment fields for the user to document any exceptions/special instructions.

In addition to adding or modifying decision blocks, the pathway author may further define the Pathway Results as Actions or Orders. In this embodiment, the following major order types are available: Lab, Imaging, Other Procedure, and Medication. However, the user is also allowed to enter CPT code for auto-detection.

The decision support system further comprises the ability to bundle several individual orders into a single step which can thereafter be used at more than one treatment node such that the treatment regimen can be re-used quickly or as a template for a step needing additional orders. For example, a combined treatment step may comprise a first lab order, a second lab order, and an imaging order, which may need to be repeated several times at different steps within the clinical pathway. For example, a cancer patient may need a first lab order, a second lab order, and an imaging order (e.g. lab order 1+lab order 2+imaging order) which can be used at one or more of several treatment nodes. For example, 5FU+XRT would correspond to a regimen of 5FU 1000 mg/m2/day CIV days 1-4, 29-32 for a patient diagnosed with anal cancer. Radiation therapy is started on day 1 and given in fractions of 1.8 Gy/day. five times per week for five weeks. This regimen may be used in several stages of an anal cancer clinical pathway for example—stage 0, and stage 1 for patients for concomitant medical conditions etc.

The fields of an Order include a type but also include other fields depending on the order. For a Lab order the fields include: Lab Name, CPT, and Comments. For an Imaging order, the fields include: Imaging Modality (CT, PET/CT, PET, MRI, US, MM, EKG etc.), Reason (Staging, Restaging, Treatment), CPT Code, and Comments. For a Procedure order, the fields include: Name, CPT, and Comments. However, a Medication order also contains subtypes such as Chemo Regimens, Single Chemo Drug, and Other Drug. Elements of Chemo Regimen and Single Chemo Drug are per Cycle (Drug, Dosage, Route, Day-x) and number of cycles. An example of a sample regimen is as follows: BEACOPP Basic Single 21 day cycle. Elements of Other Drug are drug name, route, dosage, frequency, and instructions.

In addition to the above-described fields, Orders may also include a Description field (e.g. Initial work up order set), a Comments field (e.g. please ask patient to schedule both lab and PET CT on same day), and a Notify field (e.g. select authorized user and type of notification—email, include patient details or not).

Actions are descriptive; for example, “Terminate patient's 1st line of therapy”. In this embodiment, several Actions are allowed to be bundled into a single step (e.g. terminate first line and begin second line). Fields of an action include Description, Comments, and Notify (e.g. select authorized user and type of notification—email, include patient details or not).

In a linear or process view, the decision support system enables users to edit pathway blocks on a graphical interface. For example, a user may double-click on a decision block and thereafter change its properties. The system also allows users to delete entire building blocks; insert new building blocks from a palette; and save blocks as new.

The decision support system further allows a user to display any pathway and print it or export to PDF. The system also allows a user to enter in several individual pathways and automatically create a process view of selected groups of pathways. Moreover, the system allows a user to simulate a single patient's response tree before executing.

One embodiment of the decision support system allows 2 roles—read only and read-and-write; however, roles may go across the pathway hierarchy. For example, one user may have read only access to prostate cancer pathways, but full read-and-write access to ovarian cancer pathways.

The decision support system allows health care providers such as medical doctors, nurse practitioners and medical assistants to identify a best possible treatment pathway for each patient. First, the system enables a user to execute a pathway in Planning or Simulation mode. All patient appointments (orders) are used to generate a mock chart that visualizes usage and cost of material, resources and drugs. The user is also able to view planning mode for a date range and for all future unscheduled patients. The decision support system comprises visualization options whereby attributes for each step are accessible for each step within a pathway. By providing access to the materials, cost, resources, etc. for each step within a pathway, a care provider is not only able to better plan resources for a patient's entire treatment through the pathway, but also able to modify pathways for each individual patient if certain treatments provided in the pathway are not advisable for the patient, may not be covered by a patient's insurance, and various other reasons which may require or suggest modifying pathways for each patient. For example, a step in Patient X's clinical pathway provides treatment for cancer utilizing a certain cancer drug, whereby cancer drugs are generally provided in a kit. The kit may comprise drugs A, B, and C, but Patient X may only need drug B and his insurance may only cover drug B rather than the kit. By utilizing the visualization option for this step within Patient X's clinical pathway and modifying the treatment to only comprise drug B, Patient X's care costs are reduced by the cost of the unnecessary drugs. This example is one way the decision support system of the present invention enables health care providers to provide more cost-effective health care.

Second, pathways can be executed in three ways: (1) Standalone—user logs in the pathway interface and answers question in stand-alone mode and prints results (these answers and results are not saved in the system); (2) Patient aware—user logs in the pathway interface and looks up a patient record, which auto-populates responses, and prints (also saved in the Patient record); and (3) Black box—user logs into a third party system (e.g. an emergency room system or another care provider's system) and pathways are executed remotely in black box mode through service calls and results are returned back to user (these not saved by the system).

Third, in this embodiment the user is allowed to select a single (process or linear) pathway to execute. In one case, all pathways across all therapeutic areas can be integrated into a single process pathway with a starting decision block of ICD-9 filters. All decision blocks prompt the user for an appropriate response. Additionally, the user is allowed to print the entire interview or export to PDF.

Fourth, health care providers may generate actionable order sets for a patient resulting from a pathway. All orders are exported using standards such as HL7/ELUNCS for Lab orders, HL7 for Chemo orders, HL7 for ePrescription Orders (non-chemo drugs), HL7 for Appointments, HL7 for Imaging orders. In this embodiment, the system uses IHE protocols for Master Patient Index (MPI) to ensure patient mapping between the system and the execution engine.

The decision support system comprises error logs, transaction reporting, and time-stamping for execution of order—when each order is actually executed in the system. The system logs all errors including destination system connection failure; individual order execution failure (patient mismatch, test mismatch, etc.); and messaging failures. All transactions are reportable; for example, audit trail per patient, per pathway, per user, per system, transaction initiated, transaction acknowledged, transaction completed, results received, procedure initiated etc.

The decision support system allows administrators and health care providers to analyze the effectiveness, both clinically and financially, of a pathway over a period of time through empirical benchmarking of pathway against actual clinical outcomes and financial outcomes. Graphical dashboards are used to compare multiple pathways for financial effectiveness. For example, a dashboard could compare the total cost, total claimed amounts, and total reimbursed amounts between the pathways displayed in the Cancer Clinical Pathways illustrated in FIG. 1. Graphical dashboards are also used to track pathway compliance in an organization; for example, total patients using pathway, doctors using the pathway, split by ICD, etc. The decision support system comprises a data interface for multiple care providers to access data and write to and to generate dashboards. The system further comprises standard interfaces to commercial healthcare information systems such as practice management systems, electronic medical record systems, lab information systems, radiology information systems, billing systems, and the like. Administrators and providers may choose a subset of clinically and/or financially optimized pathways from a library of pathways.

The decision support system comprises several tables enabling users to analyze and rank pathway options according to financial and clinical risk. A charge master is a table to standard expected costs per region per ICD-9/CPT. A fee schedule is a table of standard expected reimbursements per payer per ICD-9/CPT per region for eligible patients. Users may thereby rank pathways based on their known efficacy/toxicity/risk profiles. Users may choose from the following goals in order to rank pathways: lowest total cost; lowest total margin (cost—reimbursement); highest total reimbursement; highest clinically rated pathway; acceptable risk levels; or any combination of the above. The system further allows the user to choose from the following when ranking and selecting pathway options: total cost/claimed/reimbursed amounts; above metrics per order type and per individual order (e.g. cisplatin therapy cost for Pathway P1-a vis P2-c); and/or compliance determined according to total patients using pathway, doctors using a pathway, and/or the split by ICD.

A Pathway Generator tool comprising one element of the decision support system is a tool that can infer pathways currently being used by a healthcare organization by inspecting the actual historical information wherein algorithms direct which pathway to take based on the history and diagnosis of the patient in conjunction with the patient's present status. The system infers pathways empirically by inspecting historical data stored in an organization's existing information systems, potentially one or more of the following systems: practice management system, billing system, electronic health record system, hospital information management system, etc. Data analysis and data mining algorithms such as clustering are used to detect patterns in prescribed order-sets and correlate them with corresponding patterns in patients. In this embodiment, the system can output metrics such as prevalence of pathways and estimated savings from standardizing pathways. For example, prevalence of pathways metrics may be based according to patient profiles such as 72% of all male patients with smoking history and diagnosed with lung cancer are given a lab/scan work-up followed by 4 cycles of combination chemotherapy of lupron, vinblastine, avastin with a growth factor correction. Prevalence of pathways may also be based upon provider metrics and statistics; for example, Dr. Anderson prefers carboplatin (83%) over cisplatin (17%) whereas Dr. Cummings prefers the opposite (69%, 31%). Prevalence of pathways may also be based upon cost; for example, Pathway X comprising a first list of drugs, labs, scans and procedures typically costs $12,000 on average compared to Pathway Y comprising a second set of drugs, labs, scans and procedures which costs $9,000 on average. Prevalence of pathways may also be based upon reimbursement amounts such as Pathway X generally returns about $12,000 for Medicare and only about $8,000 for Blue Cross compared to Pathway Y which returns about $9,000 for Medicare and only about $7,000 for Blue Cross.

The system can generate reports that estimate potential savings from replacing costly pathways with other clinically equivalent pathways thereby enabling the system to project estimated savings from standardizing on pathways. In order to estimate these savings, the system extrapolates by expanding sample size, across time periods and across indications.

Clinical pathways are especially prevalent in chronic disease management, and more particularly in oncology. One reason for pathways in oncology is there is no single definitive treatment approach for cancer patients, even those with the same tumor type and stage. Within the various treatment options for a specific cancer patient, there is no single universally accepted set of clinical guidelines. In addition, each year, hundreds of new cancer drugs enter the market, making this a dynamically changing rule set and researchers around the world are constantly discovering new “combinations” of existing approved treatments. As health care costs skyrocket, payers are increasingly being selective about which treatments they will reimburse and how much. Consequently, two clinical equivalent pathways may not be financially equivalent such that one might make a profit and other, a loss. Administrators of large cancer centers and oncologists in small independent clinics cannot afford to overlook this aspect anymore. Scan orders and chemotherapy drugs are of special scrutiny since these are the two areas most affected by insurance rate cuts.

Marketing Methodology: The system can be used as part of a service engagement with a healthcare organization and can be used to infer pathways in use and estimate potential savings from standardizing clinical pathways. The system can also be “licensed” as a product to a healthcare organization to inspect different areas/time periods of historical data to infer pathways in use and potential savings from standardization. In addition, the system can exchange information between different companies, including pathways, experimental lab processes, clinical research processes, basic research processes and clinical trial protocols. For example, a basic research process can be “How to clone a gene” etc.

In addition, since the treatment pathways consist of a recommended series of stages/milestones/states/steps that patients go through, it is possible to generate quality metrics around standards of care, improvement goals, directional improvement, areas of focus etc. directly from the system as the patient flows through the pathway rather than collecting it from multiple disparate systems and then creating such reports as a separate process which is the norm today. These quality metrics can be aggregated and disaggregated allowing for the automatic creation of cascading quality metrics. Examples of metrics abound but currently, there exists no other automated way to collect, infer, aggregate and report on quality metrics directly from prevention, treatment and acute care pathways.

One embodiment of the computerized decision support system for designing, managing and executing clinical disease pathways for financially balanced evidence based care; the system comprises selecting a pathway that best fits a patient and the patient's condition wherein at least the following factors are considered: costs and insurance, medical personal staffing, drug distribution, risks to the patient, and additional procedures and protocal available including experimental and clinical research processes. Once created, the clinical pathway is modifiable and information regarding execution of the pathway is recorded during execution thereof, the information including at least costs incurred during execution of the pathway, resources used during treatment (personnel, medical supplies, and drugs), and results collected from procedures performed on the patient. Quality metrics can thereafter be collected an evaluated for future treatment of the current patient and future patients who may require a similar treatment plan. The computerized decision support system may further comprise the ability to share order-sets (eg. perform colonoscopy, order basic lab work, and provide 3 weeks of chemotherapy followed by 2 weeks of observation) generated from the execution of a clinical pathway with other medical information systems such as electronic medical record (EMR) systems and billing systems, through the use of data interface standards. The computerized decision support system may further comprise the ability to empirically benchmark and rank pathways based on the tracking of actual clinical and financial outcomes recorded by personnel or information systems.

The computerized decision support system may further comprise the ability to “infer” a healthcare organization's (such as a practice's or a hospital's) commonly prevalent practices for clinical pathways by inspecting their historical clinical and financial information stored in information system and further to forecast an simulate patient care based on collected data and information available from a database.

The computerized decision support system may further comprise data interfaces where user both within a healthcare network utilizing the system and users external to the network can access and edit pathway information and view collected data and metrics.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A computerized decision support system for designing, managing and executing clinical disease pathways for patient care, the system comprising:
a database comprising collected data regarding patients, commonly prevalent treatment practices, and required resources and costs associated therewith;
an editing tool for adding information to the database and editing information collected within the database;
a pathway authoring tool, the authoring tool enabling a user to create and edit one or more clinical pathways for patient care wherein the pathways may be original creations by the author or authored based on commonly prevalent treatment pathways accepted by health practitioners located within the database;
a search library for searching for criteria or decision blocks for a patient comprising a search option available to a user of the system;
visualization options enabling a user to access required resources and associated costs for each step within each pathway from the database; and
a pathway management tool for managing treatments executed according to a clinical pathway and tracking resources used and patient data collected during treatment.

2. The computerized decision support system according to claim 1 wherein the collected data comprises costs associated with procedures comprising clinical pathways, costs associated with materials consumed during execution of clinical pathways, available insurance reimbursement rules and coverage preferences, personnel requirements for treatments and actions comprising clinical pathways; drug information; drug availability, and risks and side-effects associated with activities comprising clinical pathways.

3. The computerized decision support system according to claim 1 wherein the authoring tool enables an author of a clinical pathway to bundle individual orders into a single step.

4. The computerized decision support system according to claim 1 wherein the authoring tool utilizes graphical interfaces for creating decision blocks within a clinical pathway.

5. The computerized decision support system according to claim 1 wherein the editing tool utilizes graphical interfaces for editing decision blocks within a clinical pathway.

6. The computerized decision support system according to claim 1 wherein one visualization option enables a user to compare and contrast different available clinical pathways according to clinical success rates and financial costs associated therewith.

7. The computerized decision support system according to claim 1 wherein another visualization option enables a user to simulate treatment of a patient through an entire clinical pathway.

8. The computerized decision support system according to claim 1 further comprising a data interface enabling users at each step within a clinical pathway to access a patient's clinical pathway and data associated and collected therewith.

9. The computerized decision support system according to claim 8 further comprising an external data interface whereby users at outside locations can access a patient's clinical pathway and data associated and collected therewith.

10. The computerized decision support system according to claim 1 wherein graphical dashboards are used to compare multiple clinical pathways.

11. A computerized decision support system for designing, managing and executing clinical a pathway design tool for authoring and editing at least one clinical pathway for treatment of a patient, each pathway comprising a series of activities for treatment of a patient;
a pathway manager for initiating and managing authored pathways through a patient's treatment;
a database comprising collected data regarding patients, commonly prevalent treatment practices, and required resources and costs associated therewith;
a search library for searching for criteria or decision blocks for a patient comprising a search option available to a user of the system;
graphical user interfaces coupled with the pathway design tool and pathway manager; and
an execution manager which implements activities of each clinical pathway;
wherein the collected data comprises costs associated with procedures comprising clinical pathways, costs associated with materials consumed during execution of clinical pathways, available insurance reimbursement rules and coverage preferences, personnel requirements for treatments and actions comprising clinical pathways; drug information; drug availability, and risks and side-effects associated with activities comprising clinical pathways;
wherein the pathway manager collects data during patient treatment which can thereafter be accessed and additional data entered for each patient, event, and activity comprising a clinical pathway.

12. The computerized decision support system according to claim 11 wherein activities comprise multiple activity types, each activity type comprising an event template comprising medical components of treatment and conditional expressions necessary to implement sequencing of activities within the clinical pathway.

13. The computerized decision support system according to claim 11 wherein the pathway manager utilizes a worklist comprising a list of activities in a queue for a specific user of the system to thereafter select a next activity and prioritize remaining activities.

14. The computerized decision support system according to claim 11 wherein the pathway manager comprises a visualization option enabling a user to compare and contrast different available clinical pathways according to clinical success rates and financial costs associated therewith.

15. The computerized decision support system according to claim 14 wherein another visualization option enables a user to simulate treatment of a patient through an entire clinical pathway.

16. The computerized decision support system according to claim 11 further comprising a data interface enabling users at each step within a clinical pathway to access a patient's clinical pathway and data associated and collected therewith.

17. The computerized decision support system according to claim 16 further comprising an external data interface whereby users at outside locations can access a patient's clinical pathway and data associated and collected therewith.

18. The computerized decision support system according to claim 11 wherein graphical dashboards are used to compare multiple clinical pathways.
